(19) United States
(12) Patent Application Publication
(10) Pub. No.: US 2016/0309959 A1
(43) Pub. Date: Oct. 27, 2016

(54) KITCHEN APPLIANCE WITH OPENING MECHANISM

(71) Applicant: KONINKLIJKE PHILIPS N.V, Eindhoven (NL)

(72) Inventors: CHUN PONG YUAN, EINDHOVEN (NL); QINGXIANG OU, EINDHOVEN (NL); BENGT IVAR ANDERS IVARSSON, EINDHOVEN (NL)

(21) Appl. No.: 15/103,007

(22) PCT Filed: Dec. 23, 2014
(86) PCT No.: PCT/EP2014/079100

§ 371 Date: Jun. 9, 2016

(30) Foreign Application Priority Data
Dec. 26, 2013 (CN) PCT/CN2013/090564
Feb. 24, 2014 (EP) 14156338.7

(51) Int. Cl. A47J 43/044

(52) U.S. Cl. CPC A47J 43/044; A47J 2043/04481

(57) ABSTRACT

The invention relates to an appliance (100) for processing food (130), comprising a base (140) having a base stand (140b), an arm (160) for attaching a processing accessory (120), a pivoting joint (153) connecting the base stand (140b) and the arm (160), the pivoting joint (153) being arranged for enabling the arm (160) to move between an operational position (P1) and an open position (P2) via a rotation (151) around a pivoting axis (150), the pivoting axis (150) being substantially in a main horizontal plane (111, 112) of the appliance and at an oblique angle (152) compared to a main vertical plane (111, 113) of the appliance. This appliance uses less vertical space when the arm is in the open position, and it allows a user better access to the processing accessory.

### FIELD OF THE INVENTION

The invention relates to an appliance for processing food, in particular an appliance that can move from an operational position to an open position, such as, for example, a kitchen appliance.

### BACKGROUND OF THE INVENTION

Patent WO 2011/147675 describes a kitchen appliance having a main body and a pivoting arm, which is arranged pivotably on the main body at a bearing. An accessory can be attached at the end of the arm. The kitchen appliance has a motor for driving a rotation of the accessory, for example for mixing food. The pivoting arm is arranged to pivot around a horizontal pivoting axis, when the kitchen appliance is being used and placed on a horizontal surface. By pivoting the pivoting arm, the appliance can be moved between a close configuration and an open configuration. In the close configuration, the arm is oriented horizontally, enabling the accessory to extend downward to a space for placing the food to be processed. In the open configuration, the arm points upward and the accessory is pivoted upward away from said space.

Such type of appliance has the drawback that a large space is required to fully open the pivoting arm. Moreover, accessibility to the accessory by user is not easy.

### SUMMARY OF THE INVENTION

It is an object of the invention to provide an improved appliance for processing food that can move from an operational position to an open position.

To this end, it is proposed an appliance for processing food that comprises a base having a base stand, an arm for attaching a processing accessory, and a pivoting joint connecting the base stand and the arm, the pivoting joint being arranged for enabling the arm to move between an operational position and an open position by a rotation around a pivoting axis, the pivoting axis being substantially in a main horizontal plane of the appliance and at an oblique angle compared to a main vertical plane of the appliance.

Defining an oblique angle is advantageous because the appliance requires less vertical space when the arm is in the open position, for the reason that the arm is moved non-parallel relative to the main vertical plane toward the open position. Moreover, it allows the processing accessory to rotate upwards in the open position, and facing the user, which facilitates a user to change, remove or clean the accessory or access the food in the bowl.

These and other aspects of the present invention will become apparent from and be elucidated with reference to the embodiments described hereinafter.

### BRIEF DESCRIPTION OF THE DRAWINGS

FIG. 1a illustrates a frontal view of an appliance for processing food in an operational position,

FIG. 1b illustrates a top view of the appliance in the operational position,

FIG. 2a illustrates the frontal view of the appliance in the open position,

FIG. 2b illustrates the top view of the appliance in the open position,

FIG. 3a illustrates an elevated view of the appliance in the open position, depicted in a less schematic and more realistic way,

FIG. 3b illustrates a lateral elevated view of the appliance of FIG. 3a in the operational position, and

FIG. 3c illustrates a similar lateral elevated view of the appliance but in the open position.

It should be noted that items that have the same reference numbers in different figures, have the same structural features and the same functions. Where the function and/or structure of such an item has been explained, there is no necessity for repeated explanation thereof in the detailed description.

### DETAILED DESCRIPTION OF THE INVENTION

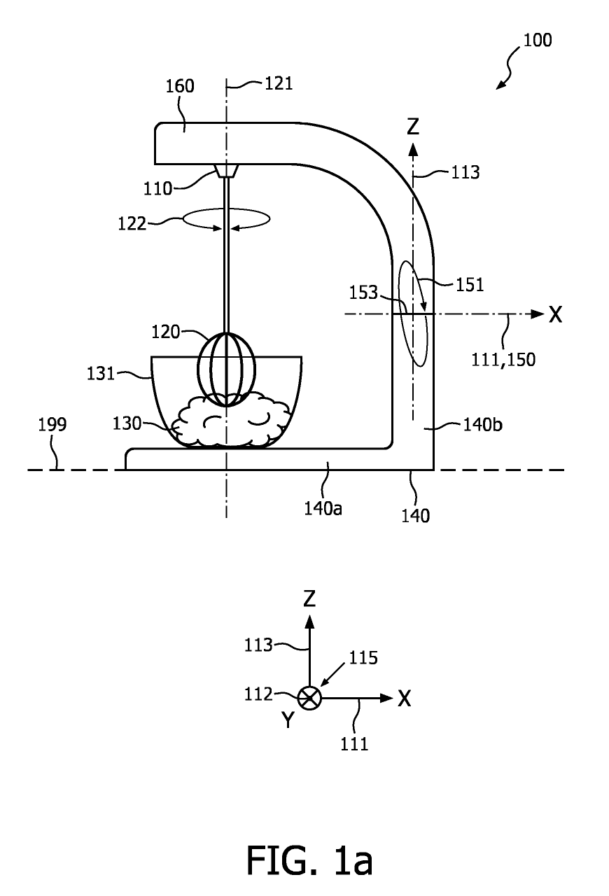

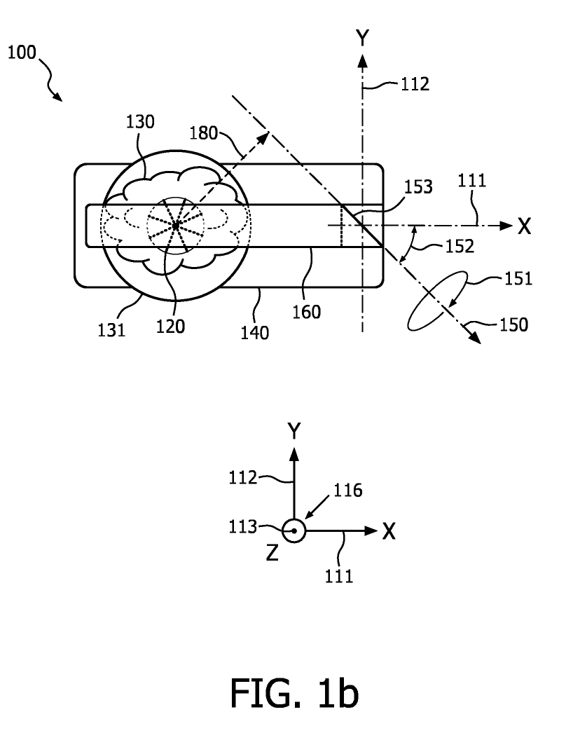

FIG. 1a illustrates a frontal view of an appliance 100 for processing food 130 in an operational position referred to as P1. The appliance 100 has a base 140. For example, the base consists of a horizontal base foot 140a and a vertical base stand 140b. In this illustration, the appliance 100 is shown placed on a horizontal surface 199. The appliance 100 also comprises a pivoting joint 153 connecting the base 140 and the arm 160.

The orientation of the appliance 100 is indicated by an orthogonal reference frame having an X-axis referred to as 111, a Y-axis referred to as 112 and a Z-axis referred to as 113.

Note that the term ‘horizontal’ corresponds to any element in or parallel to the plane defined by the X-direction and the Y-direction, whereas the term ‘vertical’ corresponds to the Z-direction.

If the appliance 100 is placed on the surface 199, for example a surface corresponding to a kitchen counter, and the user faces the appliance 100 in order to operate the appliance, then the user sees the appliance 100 as illustrated in FIG. 1a.

The X-axis 111 corresponds to movement sideways, to the left (negative X-direction) or to the right (positive X-direction).

The Y-axis 112 corresponds to a horizontal movement away from the user (positive Y-direction) or horizontal movement toward the user (negative Y-direction. Note that Y-axis goes into the plane of FIG. 1a, as indicated by a vector symbol 115.

The Z-axis 113 corresponds to upward vertical movement (positive Z-direction) or downward vertical movement (negative Z-direction).

The appliance 100 is intended to face the user when the appliance 100 is in operation and/or when the user manually operates the appliance 100. The appliance 100 is logically intended to face the user this way. According to the design of the appliance, the user's body is logically expected to be oriented towards the frontal side of the appliance 100. The user's body would then be oriented towards the positive Y-direction, or in other words, the user's belly button points in the direction of the positive Y-direction.

The appliance 100 therefore has a main vertical plane that represents an intended orientation of the appliance 100 when it is in use. The main vertical plane is parallel to an XZ-plane, which is spanned by the X-axis 111 and the Z-axis 113.

According to the invention, the pivoting joint 153 is arranged for enabling the arm 160 to move between an operational position referred to as P1, and an open position referred to as P2, via a rotation 151 around the pivoting axis 150. The pivoting axis 150 is substantially in a main horizontal plane (X-axis 111, Y-axis 112) of the appliance, which means that the corresponding angle is within in a range [−10, +10] degrees relative to the horizontal XY-plane. This range of [−10, +10] degrees may be used to slightly tilt the pivoting axis relative to the horizontal plane in order to fine-tune the way the arm 160 is oriented in the open position and fits in a designated space, such as a kitchen counter. The pivoting axis 150 is at an oblique angle 152 compared to the main vertical plane XZ-plane of the appliance described above.

The pivoting joint 153 has a pivoting axis 150 around which the arm 160 can be rotated, enabling the appliance 100 to move between the operational position P1 and the open position P2. For example, pivoting joint 153 is a hinge comprising the pivoting axis 150. For example, the arm 160 is intended to be equipped with an accessory holder 110 in order to attach a processing accessory 120. For example, the processing accessory 120 corresponds to a whisk to mix or beat ingredients. The appliance 100 has an internal driving unit (not shown) for rotating the processing accessory 120 around an accessory axis 121. The rotation of accessory 120 is illustrated by arrow 122. FIG. 1a shows the appliance 100 in the operational position P1 so that the processing accessory 120 is in an operational position for preparing the food 130 placed in a bowl 131 by accessory 120. The bowl 131 includes a working area wherein the food 130 is processed via the processing accessory 120.

FIG. 1b illustrates a top view of the appliance 100 in the operational position P1. The appliance 100 is viewed along a direction parallel to the Z-axis 113 and perpendicular to an XY-plane. This top view is particularly helpful for illustrating the pivoting axis 150 that lies substantially in the XY-plane. The pivoting axis 150 is shown at an oblique angle of approximately 45 degrees relative to the X-axis 111 and crossing the appliance 100 through a pivoting joint 153.

Similarly as FIG. 1a, the orientation of the appliance 100 is indicated by an orthogonal reference frame having axes X-axis referred to as 111, Y-axis referred to as 112 and Z-axis referred to as 113. An origin of said orthogonal reference frame is illustrated as being at the pivoting joint 153. Note that the Z-axis 113 comes out of the plane of FIG. 1b, as indicated by a vector symbol 116.

The appliance 100 is placed on the horizontal surface 199 that is parallel to the XY-plane, i.e. spanned by the X-axis 111 and the Y-axis 112. The appliance 100 is designed to operate above the horizontal surface 199 and to be oriented as shown in FIG. 1a when the appliance 100 is in use. In the embodiment of FIG. 1a and FIG. 1b, the appliance 100 has a base foot 140a that is designed to stand on the horizontal surface 199. The appliance 100 thus has a main horizontal plane that is parallel to the horizontal surface 199 when in use.

In this top view, the pivoting axis 150 lies in the XY-plane at an oblique angle 152 relative to the X-axis 112. This implies that the pivoting axis 150 is oriented at an angle 152 between the X-axis 111 and Y-axis 112. More generally, as described above, the pivoting axis 150 is at an oblique angle 152 compared to the vertical XZ-plane of the appliance. Term “oblique” means that angle 152 is substantially non-zero and substantially non-perpendicular. For the oblique angle 152 a range [20, 70] degrees is preferred.

When the arm 160 is rotated around the pivoting axis 150 as indicated by the pivoting rotation 151, the processing accessory 120 moves upwards out of the bowl 131, thus away from the working area and toward the open position P2. The processing accessory 120 thus moves along a path illustrated by the arrow 180. Note that the arrow 180 is straight, because it is seen from a top view, but it actually defines a circular path. The pivoting rotation 151 around the pivoting axis 150 thus causes the processing accessory 120 to move up (and to the right in this example). For example, if the appliance 100 is placed on a kitchen counter and the user faces the processing accessory 120 frontally and thus sees the appliance 100 as illustrated in FIG. 1a, then the pivoting rotation 151 moves the processing accessory 120 diagonally away from the user, thus (1) from the front of the kitchen counter towards the back of the kitchen counter, and (2) also towards the right of the user.

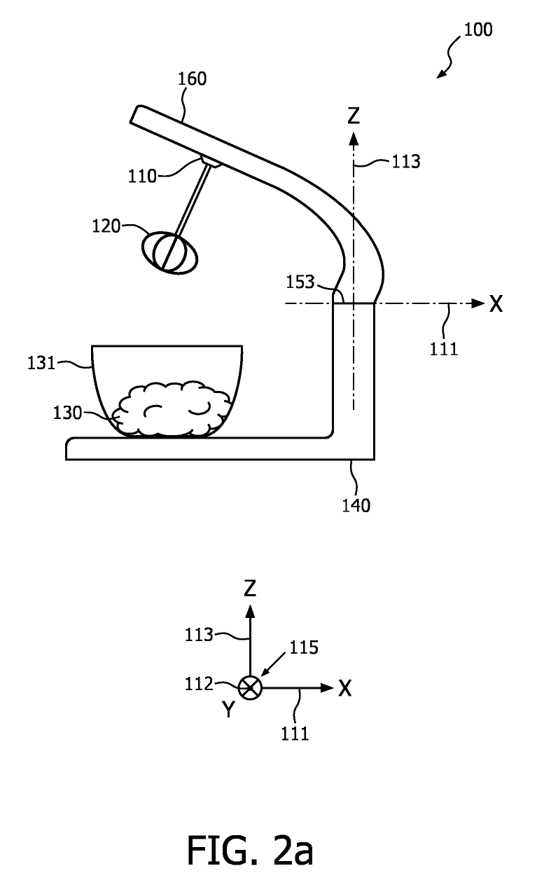

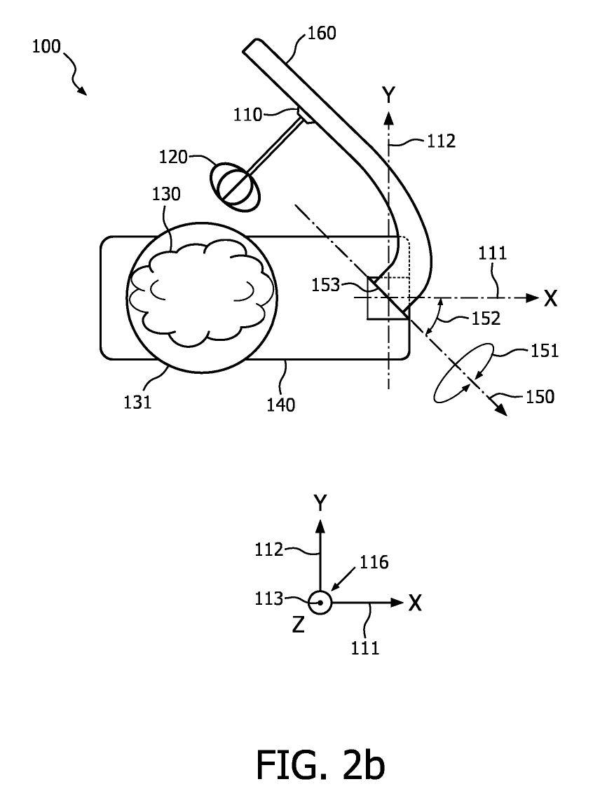

FIG. 2a illustrates the frontal view of the appliance 100 in an open position referred to as P2. FIG. 2a is similar to FIG. 1a, with the difference that the appliance 100 is in the open position P2 rather than the operational position P1. Compared to FIG. 1a, the arm 160 is rotated around the pivoting axis 150, causing the processing accessory 120 to rotationally move away from the bowl 131 (i.e. away from the working area). FIG. 2a shows that (a) the pivoting rotation 151 causes the processing accessory 120 to move upwards out of the bowl 131 and (b) the projection of the position of the processing accessory 120 on the X-axis also moves to the side (in X-direction). FIG. 2a thus shows that the arm 160 in the open position P1 extends in the Z-direction and, to a more limited extent, in the X-direction.

FIG. 2 b illustrates the top view of the appliance 100 in the open position P2. When the arm 160 moves from the operational position P1 to the open position P2, the processing accessory 120 moves away from the user (and somewhat to the right of the user in this example). FIG. 2b shows that the arm 160 extends in the Y-direction and, to a more limited extends to the X-direction.

Rotating the arm 160 around the pivoting axis 150 at the oblique angle causes the arm 160 to use limited space in the vertical direction. In FIG. 2a and FIG. 2b, the accessory holder 110 reaches a lower height than if the angle 152 would not have been tilted compared to X-axis. As a consequence, the appliance 100 uses less vertical space in the open position when the pivoting axis 150 is at said oblique angle as compared to when the pivoting axis 150 is at said non-oblique angle. Furthermore, the oblique angle causes the arm 160 to move partly away from the user (frontally facing the appliance 100, as described above), which would not occur if the angle 152 would not have been tilted compared to X-axis.

Note that the arm 160 in the previous figures has an elongated shape and lies in the main vertical plane of the appliance 100, thus in the XZ-plane in the previous figures. Rotation around the pivoting axis 150 at the oblique angle 152 causes the arm 160 to move out of the main vertical plane XZ and to, partially, roll around its own longitudinal axis X.

Because the pivoting axis 150 is at the oblique angle, the elongated arm 160 rotates in a plane non-parallel to the XZ-plane and the rotation causes the elongated arm 160 to reach a smaller than maximum height for the same predetermined amount of opening. Said roll of the elongated arm around its longitudinal X-axis causes the processing accessory 120 to face towards the user.

Said effect may be particularly useful and practical in a situation where the vertical space is limited, for example when space between a kitchen counter and a kitchen cupboard above the kitchen counter is too low to accommodate the processing accessory 120 in the open position. Having the pivoting axis 150 at the oblique angle, the appliance 100 then uses space in both the vertical direction (i.e. moving upward from the kitchen counter) and in the horizontal direction (i.e. moving frontally away frontally away from the user standing in front of the kitchen counter), and consequently requires less vertical space in the open position. In that sense, the appliance 100 uses the space on said kitchen counter in the open position in a more efficient way.

An additional benefit of rotating around the pivoting axis 150 at the oblique angle is that the accessory holder 110 opens partially toward the user. When the accessory holder 110 is opened towards the user it is easier for the user to view and access the accessory holder 110, because the accessory holder now faces the user. This is practical because it facilitates the user to easily attach and detach the processing accessory 120 in the accessory holder 110. FIG. 2b illustrates this benefit by showing that the processing accessory 120 rotates towards the user, when the appliance 100 changes from the operational position P1 to the open position P2. In the operational position the accessory holder 110 is oriented downward, whereas in the open position the accessory holder 110 is oriented partially downward and partially toward the user.

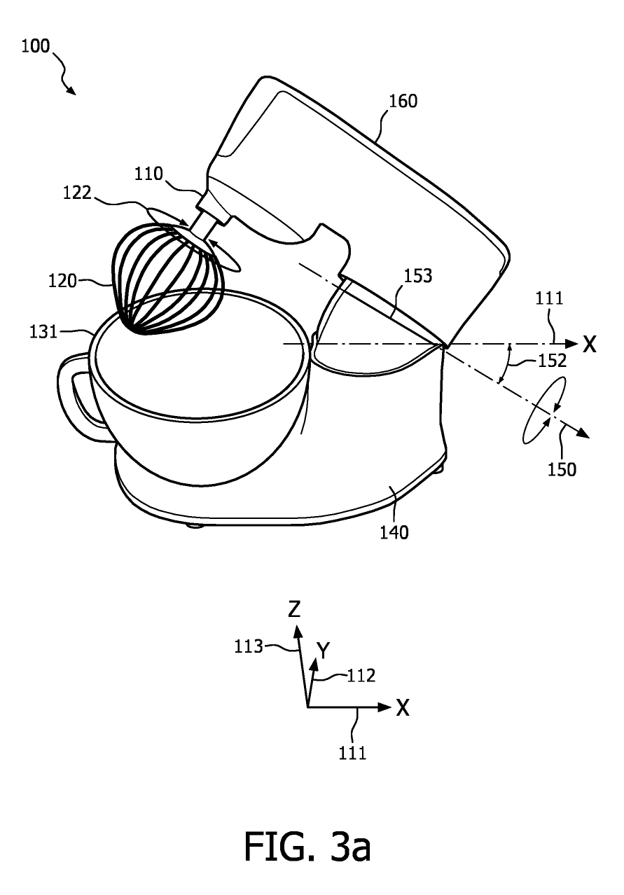

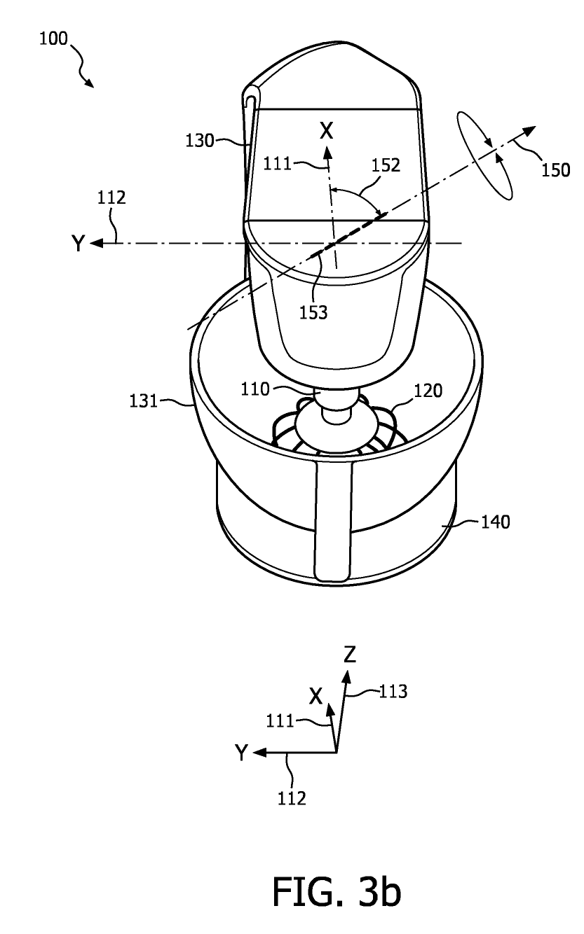

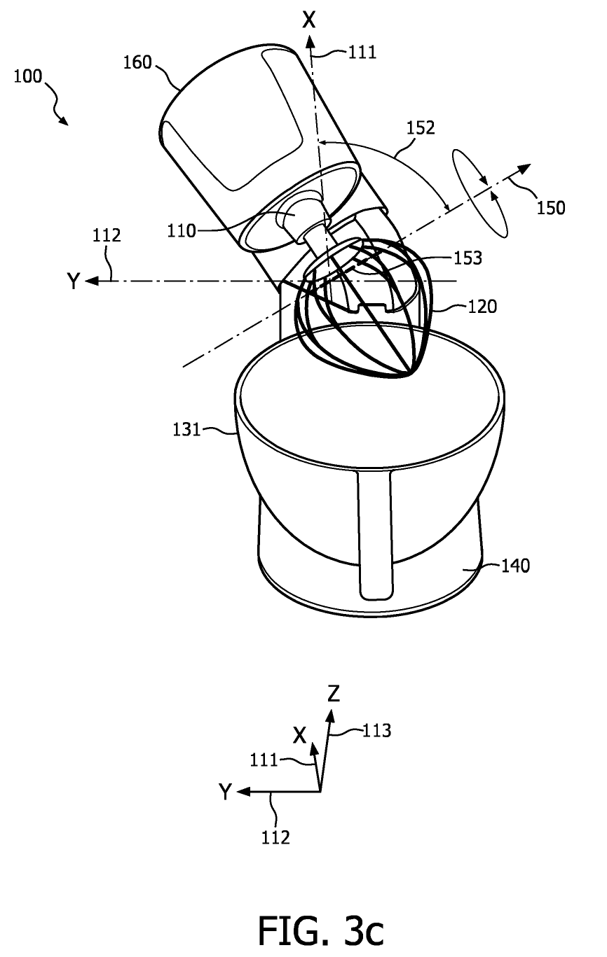

FIG. 3a illustrates a three-dimensional frontal view of the appliance 100 in the open position P2, depicted in a less schematic and more realistic way. FIG. 3a is similar to the frontal view of FIG. 1a and FIG. 2a, but with the difference that the elevated view is not parallel to the XY-plane but looks somewhat down on the XY-plane. The benefit of rotating the accessory holder 110 towards the user can be clearly seen, as the processing accessory 120 rotates upward and toward the frontally facing user. It is also shown that the arm 160 uses both vertical space and horizontal space behind (positive Y-direction) the appliance 100.

FIG. 3b illustrates a three-dimensional lateral view of the appliance 100 of FIG. 3a in the operational position P1.

FIG. 3c illustrates a three-dimensional lateral view of the appliance 100 of FIG. 3 a in the open position P2.

By comparing FIG. 3c with FIG. 3b, it can be seen that (1) the processing accessory 120 is positioned away from the food 130 and out of the bowl, (2) the accessory holder 110 is rotated toward the user enabling the user to easily view, and detach/attach the processing accessory 120, and (3) the arm 160 is rotated away from the user, using less vertical space on a kitchen counter and, instead, using more horizontal space on the kitchen counter.

A preferred range of the oblique angle 152 is [20, 70] degrees. Within this range, the appliance uses both horizontal space (in X- or Y-direction) and vertical space (in Z-direction) when it is in the open position P2.

When the oblique angle 152 is preferably at 45 degrees, the arm 160 uses said vertical space and horizontal space in approximately equal proportions.

It may be desirable that the arm 160 uses somewhat more horizontal space and less vertical space than provided via the oblique angle 152 being at 45 degrees. For example, the kitchen counter may be quite deep along the Y axis, but have very limited vertical space available because the kitchen cupboard is very low in height. In such a situation, it is desirable to use even more horizontal space and even less of the vertical space in the open position. This may be achieved by using an oblique angle of 30 degrees for example.

It may also be desirable that the arm 160 uses somewhat less horizontal space and more vertical space than provided via the oblique angle 152 being at 45 degrees. For example, the depth on the kitchen counter may be particularly limited and the vertical space may be limited to a lesser extent. This may be achieved by using an oblique angle of 60 degrees for example.

Advantageously, the appliance 100 according to the invention comprises a system allowing the oblique angle 152 to be adjustable, rather than having a fixed and given value. To allow this angle adjustment, the base stand 140b is for example mounted rotating compared to the base foot 140a. The rotation can for example be done by a second pivoting joint (not shown) that is below the pivoting joint 153 and that enables rotation of the base stand 140b around the vertical axis Z.

The user may then manually rotate the base stand 140b relative to the base foot 140a such that the appliance 100 has the oblique angle that the user desires, for example depending on the vertical space and depth space on his kitchen counter, or depending on how the user wants the accessory holder faces towards user's face in the open position P2.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements.

In the device claim enumerating several means, several of these means may be embodied by one and the same item of hardware. The mere fact that certain measures are recited in mutually different dependent claims does not indicate that a combination of these measures cannot be used to advantage.

1. Appliance for processing food, comprising:
a base comprising a base stand,
an arm for attaching a processing accessory, and
a pivoting joint connecting the base stand and the arm,
the pivoting joint being arranged for enabling the arm to move between an operational position and an open position via a rotation around a pivoting axis, the pivoting axis being substantially in a main horizontal plane of the appliance and at an oblique angle compared to a main vertical plane of the appliance.

2. Appliance as claimed in claim 1, wherein the oblique angle is in the range [20, 70] degrees.

3. Appliance as claimed in claim 2, wherein the oblique angle substantially is 45 degrees.

4. Appliance as claimed in claim 1, wherein the arm has an elongated shape that is parallel to the main vertical plane when the arm is in the operational position.

5. Appliance as claimed in claim 4, wherein an end of the arm comprises an accessory holder.

6. Appliance as claimed in claim 1, wherein the pivoting axis is at an angle of [−10, +10] degrees relative to the horizontal plane.

7. Appliance as claimed in claim 1, wherein the arm is arranged for rotating the processing accessory around an accessory axis.

8. Appliance as claimed in claim 1, wherein the pivoting join is a hinge comprising the pivoting axis.

9. Appliance as claimed in claim 1, further comprising a system allowing the oblique angle to be adjustable.

10. Appliance as claimed in claim 1, wherein the base further comprises a base foot, the base stand is mounted rotating compared to the base foot.
